(19) United States
(12) Patent Application Publication
(10) Pub. No.: US 2011/0300386 A1
(43) Pub. Date: Dec. 8, 2011

(54) Composite Hybrid Sheathing Panel

(76) Inventor: Johnny Roger Pardue, JR., Philadelphia, MS (US)

(21) Appl. No.: 13/154,564

(22) Filed: Jun. 7, 2011

Related U.S. Application Data
(60) Provisional application No. 61/352,118, filed on Jun. 7, 2010.

(51) Int. Cl. B32B 27/36; B32B 17/06; B32B 27/34; B32B 19/00; B32B 27/40; B32B 27/38; B32B 27/00; B32B 9/04; B32B 29/00

(52) U.S. Cl. 428/412; 428/411.1; 428/426; 428/474.4; 428/475.5; 428/480; 428/532; 428/423.1; 428/413; 428/500; 428/688; 428/702

(57) ABSTRACT

The invention is a building construction sheathing panel which employs a two component system, which is comprised of semi-flexible or rigid FRP laminate, adhered or otherwise affixed to a thicker and usually more rigid material such as fiber cement board, cement board, magnesium oxide board or calcium silicate board. The hybrid sheathing panel is then used to build structures in either the conventional “stick framing method” or used as a facer or “skin” in insulated or non insulated panels.

### CROSS-REFERENCE TO RELATED APPLICATIONS

This application claims the benefit of U.S. Provisional Application No. 61/352,118 filed on Jun. 7, 2010 and U.S. patent application Ser. No. 13/050,089 filed Mar. 17, 2011, which claimed the benefit of U.S. Provisional Application No. 61/343,572 filed on Mar. 19, 2010.

### STATEMENT REGARDING FEDERALLY SPONSORED RESEARCH

None.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to structural and non-structural sheathing panels. In particular, the present invention relates to such panels that have two or more layers, comprised of dissimilar materials.

B. Background

There has been a development in the construction industry of using non-wood sheathing panels in place of plywood and oriented strand board, also referred to as “OSB”, for both conventional framing and panel construction. These types of systems are typically cement board, magnesium oxide board, and calcium silicate board. These products are very useful compared to wood, and have many distinct advantages.

Cement board, fiber cement board, magnesium oxide and calcium silicate boards resist fire, insulate from heat, and can be finished with only paint or stucco, these type of materials have good structural properties in the axial compressive area, however exhibit poor performance in flexural loads, and are heavy and brittle and difficult to handle in the field.

Fiber Reinforced Plastic (FRP) laminates are light in weight, impervious to moisture and insects, and can be made fire proof. FRP laminates can be made from a wide variety of reinforcing materials including but not limited to fiberglass (woven, non-woven, stitched) and other natural and man made materials.

FRP is made by combining plastics with the aforementioned reinforcing fibers. The plastics are primarily two types of systems, thermoset resins, and thermoplastics. The thermoset resins are typically a two part system consisting of the resin and a hardener or catalyst. The thermoplastics are applied to the reinforcement in a molten state; various types of plastics are used in this process. FRP is engineered for low or high performance. High flexural and tensile strength are properties of some FRP.

In the invention, the two materials are combined, typically by adhesive bonding, or alternatively by other processes to produce a sheathing panel with much higher performance properties than either of the two materials used alone could achieve.

The resulting sheathing panels have many uses in the construction industry, including sheathing of walls, floors and roofs in conventional stick built framing, as well as being used as a skin material in structural or non-structural insulated or non-insulated panels.

### SUMMARY OF THE INVENTION

The invention is a Composite Hybrid Sheathing Panel. The invention is a building construction sheathing panel which employs a two component system, which is comprised of semi-flexible or rigid FRP laminate, adhered or otherwise affixed to a thicker and usually more rigid material such as fiber cement board, cement board, magnesium oxide board or calcium silicate board. The hybrid sheathing panel is then used to build structures in either the conventional “stick framing method” or used as a facer or “skin” in insulated or non insulated panels.

The use of the two component system is a vast improvement over a single sheet material by itself, in that the FRP laminate provides the rigid sheet material with a vastly improved flexural, tensile strength, impact resistance is also greatly improved.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

FIG. 1 is a cutaway view of FRP laminate combined with single sheet type panel;

FIG. 2 is a cross section view of single FRP laminate combined with single sheet type panel;

FIG. 3 is a cross section view of an FRP laminate “sandwiched” between two sheet type panels;

FIG. 4 is a cross section view of a Sheet type panel “sandwiched” by two FRP Laminates; and

FIG. 5 is a cross section view of a multiple layer Composite Hybrid Sheathing Panel.

### DETAILED DESCRIPTION OF THE INVENTION

The invention is a Composite Hybrid Sheathing Panel.

The invention is a building sheathing panel which employs a two part system, which is comprised of semi-flexible or rigid Fiber Reinforced Plastic (FRP) laminate, adhered, glued, chemically or mechanically bonded to a thicker and usually more rigid material such as cement, fiber cement, magnesium oxide (MGO), or calcium silicate. The resulting panel is then used in conventional construction framing as sheathing, underlayment, overlayment, or used as a facer in panel manufacturing and or construction. The invention utilizes the two part system to overcome weaknesses of individual materials, while exploiting the strengths of each individual material. The invented panels are superior in many ways to panels currently commercially available.

The sheathing panel system, utilizing FRP laminates on one or both sides of the sheathing material is unique to the invention which is designed for high strength, moisture resistance, fire resistance and easy cosmetic finishing. The sheathing panels can be made from small to very large sizes and can utilize various types of FRP laminates and various sheathing panel materials. The invented panels outperform panels made out of a single material.

The composite hybrid panel system in the invention consists of one or more laminates of Fiber Reinforced Plastic or Fiber Reinforced Polymer (FRP). FRP laminates can be made from a wide variety of reinforcing materials including but not limited to glass, polypropylene, carbon fiber, arimid, kevlar, spectra, vectran, nylon, polyamide, and high modulus polyester, and even natural material such as flax, hemp and kanaf, with the most common material being fiberglass. The reinforcing fibers can be in the form of woven, non-woven, stitched, chopped, and mats, or any combination thereof, an example being a woven roving, which is stitched to a chopped strand mat.

FRP is made by combining plastics with the aforementioned reinforcing fibers. The plastics are primarily two types of systems, thermoset and thermoplastic.

The thermoset resins are typically two part systems consisting of the resin and a hardener or catalyst. These resins can be but are not limited to: polyester, vinyl ester, phenolic, epoxy, urethane, and soy based. An example of thermo set FRP is a phenolic/fiberglass laminate made by DuraSip, LLC of Union Miss. There are many commercially available FRP laminates made by many manufacturers suitable for use in the invention.

The thermoplastic systems are applied to the reinforcement in a molten state; various types of plastics are used in this process, including but not limited to: polyethylene, polypropylene, polycarbonate, nylon, polyimide, polystyrene, and polybutylene. Typically the plastic fibers are woven or otherwise combined with the reinforcing fibers, and combined with heat and pressure to form a laminate. An example of thermoplastic FRP is “Cosmolite” which is distributed by Tekmodo of Elkhart Ind.

In the invention, any type of Fiber Reinforced Plastic (FRP) can be used to meet the performance criteria of a desired panel.

The Composite Hybrid Sheathing Panel employs sheet type panels which are affixed to the FRP laminate(s). The panels and laminates are either bonded together with adhesive (liquid or film) or other chemicals, heat bonded, or pressure bonded. The most common application is liquid adhesive bonding.

An alternative is bonding with a wet layup of the FRP directly onto the sheet type panels. This method would be accomplished by pouring or pumping, setting, or vacuum transferring the liquid thermoset resin system directly onto the cement, fibercement, calcium silicate or magnesium oxide sheets, the reinforcing fibers are applied first, or set into the liquid resin.

Another alternative is to apply the rigid board materials directly onto a FRP laminate sheet. This would be accomplished by the pouring or pumping of a liquid or slurry of magnesium oxide, cement, fibercement or calcium silicate onto the FRP sheet.

The sheet type panels can be made from many different materials to achieve the desired composite hybrid panel properties including, but not limited to; fiber cement board such as Hardie Panel, and Hardie plank and Hardie Shingle (by James Hardie Corp.), Smart Side (by Louisiana Pacific Corp.). Additionally, a profiled cement board with the look and feel of natural materials such as stone and brick can be used, examples are, but are not limited to Color Max (by Certainteed Corp.) and Nichi Board cement panels by Nichia Corp.

A relatively new material to the US market is Magnesium Oxide board; this type of board is sold as Magnum Board, Mag Board Dragon Board and Magnesia Core and Gemtree Board. There are other branded and non branded names, these types of MGO Board products can be used effectively in the invention as a sheet type panel material, or poured over the FRP in a slurry state as mentioned above. Another acceptable sheet type material is Calcium Silicate board.

The invented panels also can be made up of multiple layers of composite laminate material, and sheet type panel materials; these resulting panels could be used where extreme durability, heavy loading or even ballistic protection is required. An alternative is also to use single or multiple layers of the invented panel, cut or made to size for use as headers, splines, joists, rafters, sills, beams or posts.

The Composite Hybrid Sheathing Panel is a unique invention with wide commercial application. The drawings show different views and material combinations of the invention.

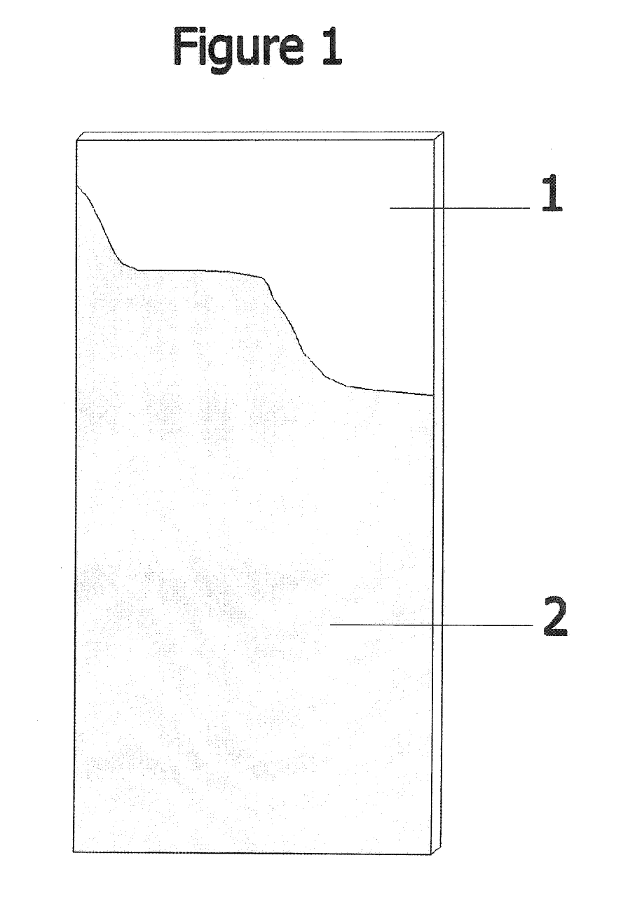

FIG. 1 is a cutaway view showing the FRP laminate over the rigid board type material, typically the FRP will be on the back side of the panel, so that the rigid sheathing board is left exposed, whoever the FRP could serve as the exposed face in certain applications.

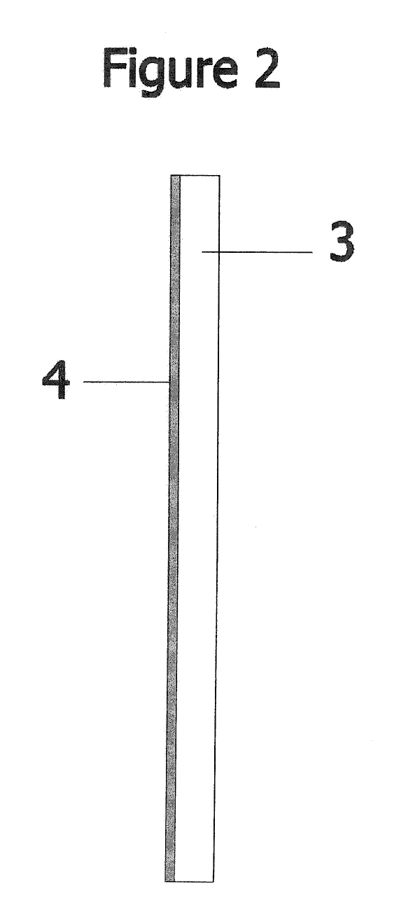

FIG. 2 is a cross section view showing the FRP combined with the rigid sheet material; the FRP can be either the hidden backside of the sheathing panel, or the exposed face.

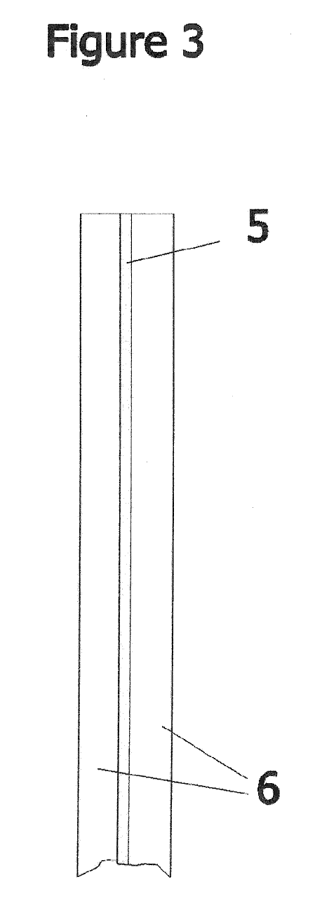

FIG. 3 is a cross section is a cross section view showing the FRP ‘sandwiched” between 2 sheets of the rigid sheet material, this application may be used where the finish of the rigid sheet material will be seen from both sides, such as in an exposed roof framing system, or where the high fire resistance of the MGO is required on both sides of the sheathing panel.

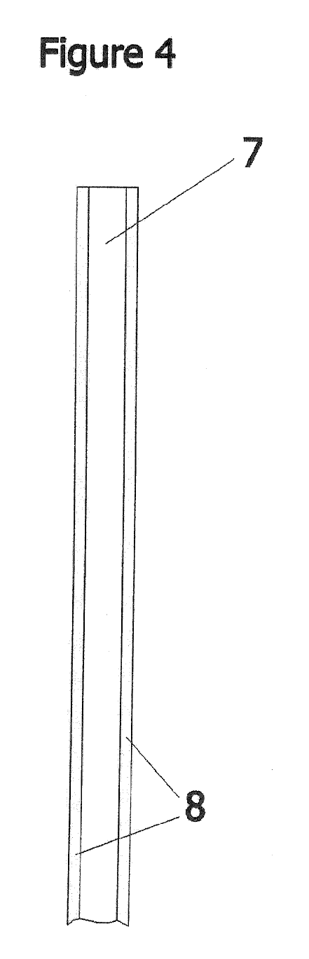

FIG. 4 is a cross section showing the rigid sheet material being sandwiched by two sheets of FRP, in this application the combination becomes a structural panel, with the rigid sheet material acting as the “core”.

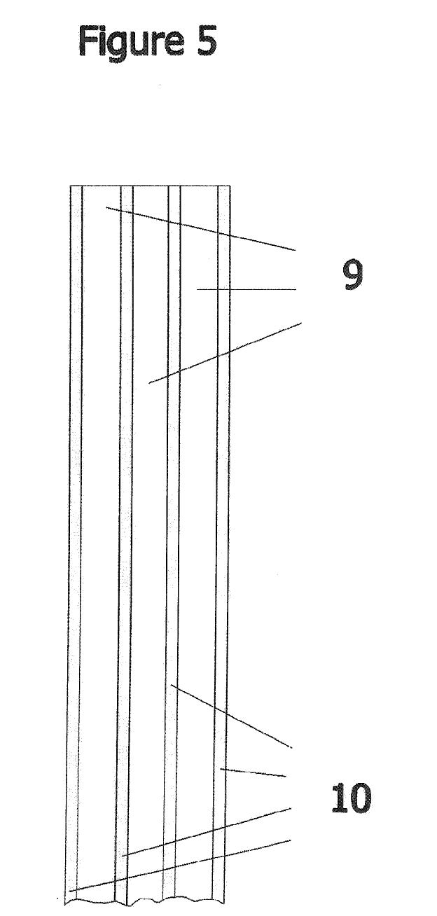

FIG. 5 is a cross section showing a multi layer “sandwich” of the FRP and the rigid board materials, this application may be uses where ultra high strength or ballistic properties are required. This type of panel could also be cut to size for use as beams, headers and posts.

The unique properties of the invention allow for many combinations of materials to achieve the desired structural and cosmetic requirements needed for different building projects.

While there are shown and described herein specific forms of the invention, it will be readily apparent to those skilled in the art that the invention is not limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance there are numerous components described herein that can be replaced with equivalent functioning components to accomplish the objectives of the present invention.

What I claim as my invention is:

1. A sheathing panel, comprising:
a combination of one or more layers of fiber reinforced plastic; and
one or more layers of cementitious or non-cementitious sheathing panels or boards combined with said one or more layers of fiber reinforced plastic.

2. A sheathing panel according to claim 1, wherein said fiber reinforced plastic contains at least one of the following reinforcing materials: glass, arimid, kevlar, spectra, carbon fiber, polypropylene, polyamide, nylon, polyester, high modulus polyester, vectran, hemp and kanaf.

3. A sheathing panel according to claim 1, wherein said fiber reinforced plastic contains at least one of the thermoset systems: phenolic, polyester, vinyl ester, epoxy, polyurethane and soy based.

4. A sheathing panel according to claim 1, wherein said fiber reinforced plastic contains at least one of the thermoplastic systems: polyethylene, polypropylene, polyvinylchloride, polycarbonate, polyamide, nylon, polystyrene and polybutylene.

5. A sheathing panel according to claim 1, wherein said cementitious or non-cementitious sheathing type boards or panels contains at least one of the following: cement board, fiber cement board, magnesium oxide board and calcium silicate board.
